(19) United States
(12) Patent Application Publication
(10) Pub. No.: US 2006/0071122 A1
(43) Pub. Date: Apr. 6, 2006

(54) Full body teleportation system

(76) Inventor: John Quincy St. Clair, San Juan, PR (US)

Correspondence Address: JOHN ST. CLAIR;4A, 52 KINGS COURT, SAN JUAN, PR, 00911, US

(21) Appl. No.: 10/953,212

(22) Filed: Sep. 29, 2004

(51) Int. Cl. B64C 39/00

(52) U.S. Cl. 244/62

(57) ABSTRACT

A pulsed gravitational wave wormhole generator system that teleports a human being through hyperspace from one location to another.

### BRIEF SUMMARY OF THE INVENTION

This invention is a system that teleports a human being through hyperspace from one location to another using a pulsed gravitational wave traveling through hyperspace.

### BACKGROUND OF THE INVENTION

The basis for this invention is an event, referring to FIG. 1, occurring on May 2, 2004, in which the inventor (“he”) personally experienced a full-body teleportation while walking to the bus stop (A) along a road (B) that runs perpendicular to the nearby commercial airport runways where planes are landing. There is a wide iron grating (D) for water drainage that crosses the road at the center of the bus stop. The grating width is such that one has to make a concerted effort to jump across it in order to get from one side to the other. Approximately 50 meters from the iron grating, he (E) felt a vertical wave (F), similar to a flag waving in the breeze, traveling down the street toward the bus stop. The wave velocity was about 1 meter per second, which was slightly faster than his walking speed. In the next instance, he (G) found himself down the street near the corner of the next block. Realizing that he had passed the bus stop, he turned around to see the iron grating approximately 50 meters up the street in back of him. Because there was no recollection of having jumped across the iron grating nor of having passed the bus stop's yellow marker line, he realized that he had been teleported a distance of 100 meters while moving along with the traveling wave. It was obvious that the wave was pulsed because the front edge overtook the inventor, moved with him momentarily, and then the back edge of wave left him as it moved on down the street. While contemplating this sequence of events, he then looked up and saw in a span of a few seconds a twin-turboprop airplane (C) in the distance crossing above the road while making a shallow descent in order to land at the airport.

It took a number of days in order to understand this sequence of events. The explanation involves knowledge of a wide range of subjects such as gravitation physics, hyperspace physics, wormhole electromagnetic theory and experimentation, quantum physics, and the nature of the human energy field.

It is obvious from the above scenario that the airplane momentarily crossing perpendicular to the road generates the aforementioned pulse. Because the airplane has an engine on each wing, there are two propellers which conceivably are rotating out-of-phase with each other. That is, the blade of one propeller could be pointing up and the equivalent blade on the other engine could be pointing in a slightly different direction. Notice that the tip of the blade traces out a helix as the plane is landing.

In gravitation physics, referring to FIG. 2, it is known that two masses of mass m1 and m2 (A,B) attached by lever arms slightly offset by an angle δθ along the radial direction to the rotating shaft (C), will produce a gravitational wave (D) traveling perpendicular to the shaft. The mass and wave are referred to as the source and receptor respectively. Referring to a side view looking along the shaft FIG. 3, the product of the mass m times the angular acceleration a is a constant such that m1a1 is equal to m2a2. The distance between the masses is length L, which makes an angle θ with the horizontal axis. The difference in time of travel to the receptor gives rise to a difference in phase δθ equal to the angular velocity ω of the rotating shaft times the length L times the cosine of the angle θ
δθ=ωL cos(θ)

At the receptor, the amplitude of the wave is equal to the mass times the acceleration times the phase difference divided by the radius r to the receptor

$$A = \frac{{m}_{1} {a}_{1}}{r} δθ \approx ( \frac{m ω L sin ( θ )}{r} ) ( ω L cos ( θ ) ) = \frac{m {ω}^{2} {L}^{2} sin ( 2 θ )}{r}$$

Even though the turboprop airplane engines have a high rotational speed and a large separation distance between masses, the gravitational wave which is produced is small and not noticed. The problem is that the gravitational constant G in this dimension has such a small value equal to the speed of light c squared divided by the linear mass Ω of the universe

$$G = \frac{{c}^{2}}{Ω} = \frac{{( 299792458 m \text{/} s )}^{2}}{1.346812891 \cdot {10}^{27} kg \text{/} m} = 6.673200002 \cdot {10}^{- 11} \frac{{m}^{3}}{kg {s}^{2}}$$

On the other hand, a gravitational wave traveling in hyperspace would be magnified enormously due to the face that the linear mass is so small. The magnitude of the gravitational constant in hyperspace can be estimated in the following manner. At the beginning of the 20th century, a man's parents were dying of tuberculosis. With their permission, he placed them and their beds on weighing scales. When each one passed away, each scale registered a drop in mass equal to 0.071 kilograms. This is the mass of the hyperspace energy being which resides in the physical body. Because hyperspace is co-dimensional with our dimension, the energy being interpenetrates the body and controls its movement.

Referring to FIG. 4, a human being has seven vortices (A through G) which are aligned along the centerline of the body. Each vortex is actually a co-gravitational field K which causes a pendulum placed in the field to spin in circles. For this reason, the K field has units of inverse seconds similar to an angular velocity. The vortex transports energy from our dimension to the energy being located in hyperspace. The gravitational field g and the co-gravitational field K are equivalent gravitationally to the electric E field and the magnetic B field found in electromagnetism. The equivalent gravitational solution to an electromagnetic problem can be obtained by substituting the following gravitational constants for the electromagnetic constants

| Electromagnetic | Gravitational |
|---|---|
| q (charge) | m (mass) |
| ρ (volume charge density) | ρ (volume mass density) |
| σ (surface charge density) | σ (surface mass density) |
| λ (line charge density) | λ (line mass density) |
| J (convection current density) | J (mass current density) |
| E (electric field) | g (gravitational field) |
| B (magnetic field) | K (co-gravitational field) |
| ε₀ (permittivity of space) | −¼πG |
| μ₀ (permeability of space) | −4πG/c² |
| −¼πε₀ or −μ₀ c²/4π | G (gravitational constant) |

Referring to FIG. 5, each vortex is connected through the pineal gland by light cords to a separate hyperspace quantum well having its own frequency and dimension. The reason for this separation is that the conical spiritual eye, attached to vortex B, has to have its own energy structure which is different from vortex (A) which is connected to the quantum energy field in which the mental processes are developed. Due to the high speed of light in our dimension, the quantum wells are the size appropriate to molecules and atoms. In hyperspace, where the speed of light is one meter per second, the quantum wells are huge and can be manipulated. This manipulation has shown that the quantum wells are in the shape of a cube about a meter on a side. This makes the whole structure about seven meters tall for a volume of seven cubic meters. Thus the mass density ρ of hyperspace is about

$${ρ}_{h} = \frac{.071 kg}{7 {m}^{3}} = .01 \frac{kg}{{m}^{3}}$$

which per unit area is the same value. Therefore the hyperspace gravitational constant is equal to

$${G}_{h} = \frac{{c}^{2}}{{Ω}_{h}} = \frac{{( 1 \frac{m}{s} )}^{2}}{.01 kg \text{/} m} = 100 \frac{{m}^{3}}{kg {s}^{2}}$$

The enormous magnification of the gravitational constant is therefore of the order of

$$\frac{{G}_{h}}{G} = \frac{100}{6.6732 \cdot {10}^{- 11}} \approx 1.5 \cdot {10}^{12}$$

The question is how does this amplified gravitational wave created by the rotating propellers and turbines get into hyperspace from our dimension?

The answer comes from experiments done using the ancient Chinese form of breathing known as Chi Kung. Using this breathing technique, we have been able to levitate the human body over six feet in the air. The internal temperature of the stomach is around 200 degrees Fahrenheit. By simultaneously squeezing the diaphragm to bring hot air up through the lungs, and breathing through the nose to bring cold air down, rotating vortices are generated in the lung passages when these two air masses meet and twist around each other as depicted in the famous Yin-Yang diagram. Because the lung has variable diameter passages from the large diameter at the throat to the final small air sacs, there is a spectrum of rotating frequencies.

From quantum physics it is known that if there is a temperature fluctuation occurring among a group of harmonic oscillators in the environment, then Planck's reduced constant [symbol] is increased by the cotangent of the constant times the frequency ω of the oscillator divided by twice Boltzmann's constant k times the temperature T

$$ℏ = ℏ coth ( \frac{{ℏω}_{n}}{2 kT} )$$

The effect of increasing Planck's constant, referring to FIG. 6, can be seen in the tetrahedron diagram. This diagram, of which there are now over 4000, plots the natural logarithm of mass on the vertical axis versus the natural logarithm of wavelength on the horizontal axis. In terms of mathematics, it is a subspace logarithmic manifold which projects geometrically the physics constants into our 4D spacetime dimension. That is, it is the geometry of the tetrahedron circumscribed by the sphere that determines the mass of the proton and electron. The mass of the electron times its wavelength is equal to the mass of the proton times its wavelength which in turn is equal to Planck's constant h divided by the speed of light c

$${m}_{e} {λ}_{e} = {m}_{p} {λ}_{p} = \frac{h}{c}$$

Taking the natural logarithm of the above equation shows that the mass plus the wavelength is equal to what is termed the base constant

$$ln ( {m}_{e} ) + ln ( {λ}_{e} ) = ln ( \frac{h}{c} ) = - 95.91546344$$

which is represented in FIG. 6 by the 45 degree line (A) from point (a) on the horizontal axis to the vertical axis at point (b). The electron is located at point (c) which is the intersection of the electron wavelength (B) with line (A). The electron wavelength (B) reflects off the sphere (D) at points (d) and (e) and returns along line (C) as the electron mass. As shown in tetrahedron diagram tet0565, stored in the Library of Congress, the clockwise path of the electron transitions into the counter-clockwise path of the proton showing that the electron and proton are one and the same particle. Because the electron and proton travel in opposite directions along the path, they have the same charge but of opposite sign.

Our dimension is represented by Planck box (E) which is bounded by the Planck mass and the Planck wavelength. The Planck mass is equal to the linear mass of the universe times the Planck length which is the bottom limit of our dimension. The Planck wavelength is 2π times the Planck length. Notice that the electron is located within the Planck box.

Referring to FIG. 7, if there is an increase in Planck's constant due to the temperature fluctuations among the harmonic oscillators, the 45 degree base line (A) moves to the left on the tetrahedron diagram as shown by line (F). Because of the increase in the base constant, there is a corresponding increase in the electron mass and wavelength. The electron moves from point (c) to point (f) which places it at the edge of the Planck box (F) which is the boundary between space and hyperspace. At point (f), the electron is essentially no longer in our dimension.

Referring to FIG. 8, imagine a box (A) filled with nine electron oscillators (B). If Planck's constant is increased near the three oscillators in the middle, these electrons will leave this dimension. This leaves six oscillators as shown in the box (C). However, box (C) is the equivalent of box (D) in which there are still nine positive mass oscillators together with 3 negative mass oscillators. Thus there is an accumulation of negative energy (−ρ) when information is lost from the environment to another dimension.

Dr. Kip Thorne, who co-authored the book Gravitation with Dr. Archibald Wheeler of Princeton University, has shown in a General Relativity spacetime curvature calculation that negative energy is required to open and stabilize the throat of a wormhole between space and hyperspace. The accumulation of negative energy in the aforementioned example generates wormholes between into hyperspace. Hyperspace has a low energy density because of the reduced speed of light in that dimension. Ordinarily, energy would not flow from hyperspace to space because space has a higher potential than the potential of hyperspace. This, of course, is the reason that the body vortices can flow energy into the energy field of the human being who is located in hyperspace. By creating negative energy, the potential becomes reversed such that low density hyperspace energy flows into our dimension as seen by the positive head
PE=ρ_{hyperspace}−(−ρ_{space})=+2ρ
The low-density energy fills the body which allows a human being to float upwards like a helium balloon as verified by Chi Kung breathing as well as spinning on a motorized platform known as the Chakra Vortex Accelerator. The latter device resulted in the first mechanical means to produce anti-gravity.

The process of creating spinning thermal fluctuations is the same as found in the hot air vortices created by the jet airplanes landing at the airport near the road where the full-body teleportation occurred. Large vortices are created over the wing of the airplane at the same time that the turbine engines are spinning hot vortices into relatively cold air. These conditions produce wormholes between space and hyperspace. It takes a twin turboprop airplane landing behind the jet to generate the gravitational wave in the region where the wormholes have formed. The gravitational wave then traverses the wormholes into hyperspace, becoming highly amplified due to the change in linear mass and speed of light. Because the propeller blades are co-linear with the road, the gravitational wave travels in the direction along the road where it was encountered by the inventor.

From experiments with cavitating bubbles (see patent application Cavitating Oil Hyperspace Energy Generator), it was found that it is possible to produce a wormhole if the surfaces of the bubble collapse asymmetrically. A symmetric collapse of a spherical bubble produces enormous spacetime curvature distortions. An asymmetric collapse, using a magnetic field to distort the collapse, produces, in addition to the same severe spacetime distortions, negative energy as the bubble collapses. Due to some General Relativity considerations, the wormhole that is created starts rotating in a manner similar to the beacon light produced by a lighthouse.

Referring to FIG. 9, due to the forward helical motion (A) of the propellers (B) as the airplane crosses the road, the pulsed gravitational wave (C) is skewed backward at an angle (D). Due to the wormholes created by the presence of thermal vorticity fluctuations generated by the wing and turbines of the airplane, this skewed wave moves into hyperspace where it is highly magnified and detected by the inventor.

Referring to top view FIG. 10, the gravitational wave (A) causes a skewed compression and expansion of the hyperspace quantum wells (B) which constitute the human energy being. Due to this asymmetric distortion in the xy-plane, the quantum wells take the physical body out of dimension as long as the wave pulse is traveling with the human energy field. Once the back edge of the gravitational wave moves on past the quantum wells, the body is then brought back into dimension.

### SUMMARY OF THE INVENTION

It is the object of this invention to teleport a human being from one location to another by creating a pulsed gravitational wave traveling through hyperspace that asymmetrically compresses and expands the quantum wells of the human energy being. This spacetime curvature distortion of the hyperspace quantum wells pulls the physical body out of dimension such that the human being is teleported along with the wave. As the pulsed wave moves on past the quantum wells, the human is brought back into dimension at some distant location. The invention requires (1) a device that will generate a wormhole between space and hyperspace, and (2) a device that will generate a gravitational wave which can be inserted through the wormhole.

Referring to FIG. 11, a magnetic vortex wormhole generator has already been developed which generates a wormhole between space and hyperspace as described in a previous patent application entitled Magnetic Vortex Wormhole Generator. Using this generator, it was found that smoke blown through one side of the coil does not appear on the other side of cylindrical coil. The smoke flows through the wormhole and appears in a hyperspace co-dimension. It was this experiment that resulted in making first contact with the androids of the Grey aliens who told me, in a remote viewing session, that “We saw you blowing smoke into hyperspace.”

The wormhole generator consists of two concentric cylindrical coils (A,B), one of larger radius than the other, made of thin transformer iron laminate wrapped in opposite directions with one continuous wire driven by a sinusoidal current. The solenoidal coil generates a magnetic field through the laminate. Because the electrical current flows in opposite directions at different radii through the two windings, bucking electric fields (C) are created along the centerline of the generator. These radially-offset magnetic fields and bucking electric fields, as shown by a calculation using Einstein's General Theory of Relativity, generate both an enormous spiking spacetime curvature and negative energy at small radius along the centerline where the wormhole is formed. The gravitational wave generator is then coupled to this wormhole generator.

Referring to FIG. 12, it is known from gravitation physics that injecting an electromagnetic wave (A) into a hollow toroidal waveguide (B) produces a hyperbolic spacetime curvature stress (C) in the plane of the waveguide. The tips of the arrows indicate compression and the tail of the arrows indicate expansion or stretching of spacetime. The reason for this spacetime curvature is because the waveguide forces the electromagnetic wave to curve around and travel in a circle. Spacetime has to compensate for this toroidal-generated stress by creating hyperbolic lines of stress in the inner plane of the toroid so that the overall spacetime curvature is zero. For a greater gravitational effect, three toroidal waveguides, phased 120 degrees apart, are used to seal off the curvature.

Referring to FIG. 13, the three toroids create a rotating, twisting, vertical propagating gravitational field (A) through the centerline of the toroids provided that the period of the electromagnetic wave is twice the period of the gravitational wave. This phase relationship is adjusted by selecting the correct radius for the frequency of the monochromatic wave.

In order to effectively use this gravitational wave, referring to FIG. 14, three phased toroidal waveguides (A,B) are mounted at the top of each of two identical square granite obelisks (C,D). The two obelisks are offset by a short distance between them. As the vertical gravitational wave rotates around along the vertical axis inside the obelisk, the edges of the square obelisks are compressed and expanded such as to create two cylindrical asymmetric gravitational waves traveling radially outward.

Referring to FIG. 15, these waves meet to form a plane gravitational wave (A) which travels down the centerline between the two obelisks.

Referring to FIG. 16, the full body teleportation system consists of the twin granite obelisks (A,B) on which are mounted near the top of each the toroidal waveguides (C,D) which produce the pulsed gravitational waves (E,F) that run the length of the obelisks. Because the gravitational wave is rotating inside the obelisk, the granite stone undergoes a very small asymmetrical compression and expansion. A cylindrical gravitational wave propagates out from each obelisk such that along the centerline between the two there is generated a plane gravitational wave. This wave enters the wormhole (H) created by the magnetic vortex generator which is located a short distance from and parallel to the obelisks. The wave is amplified by a factor of almost 10 ¹³ when it enters the hyperspace co-dimension.

### A BRIEF DESCRIPTION OF THE DRAWINGS

FIG. 1. Perspective view of site where full-body teleportation occurred.

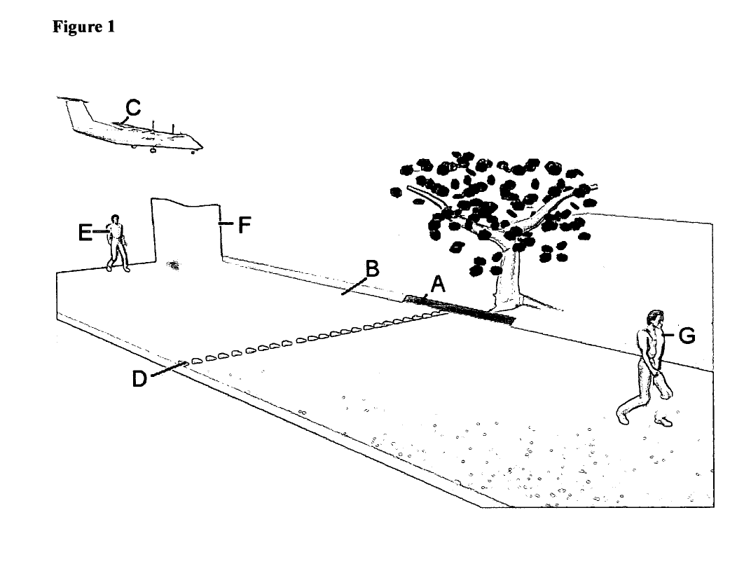

FIG. 2. Perspective view of gravitational wave generator.

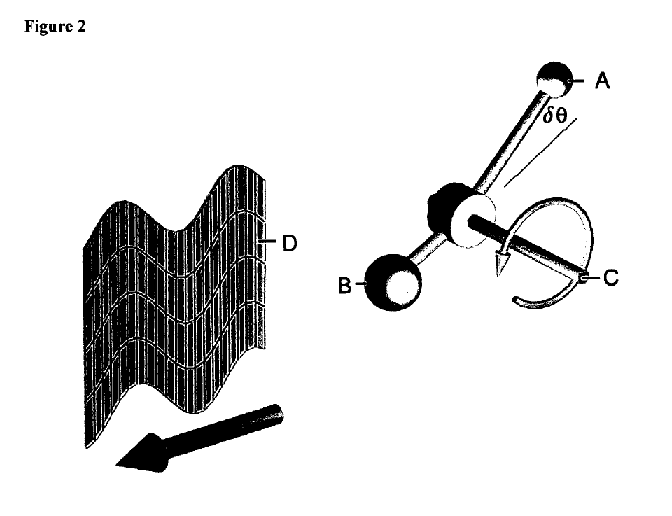

FIG. 3. Planar view of gravitational wave generator.

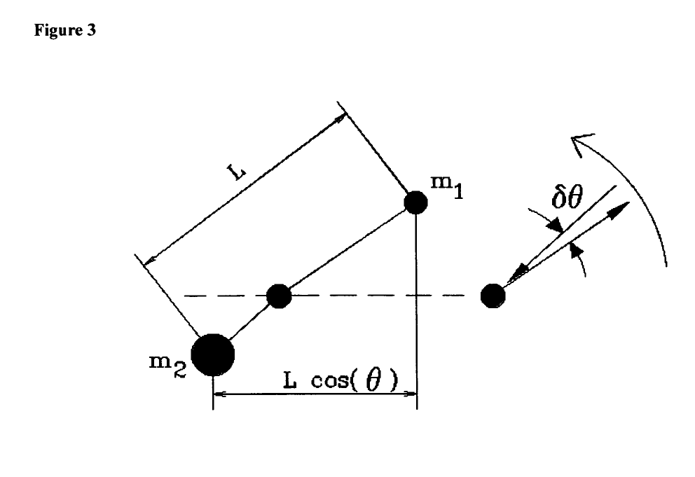

FIG. 4. Perspective view of seven vortices of human energy being.

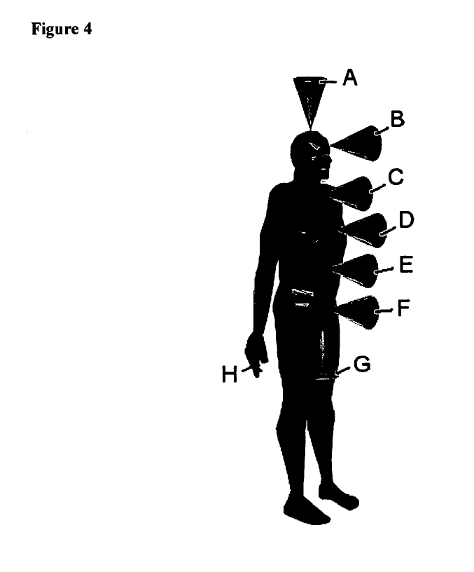

FIG. 5. Perspective view of seven large quantum wells of human energy being.

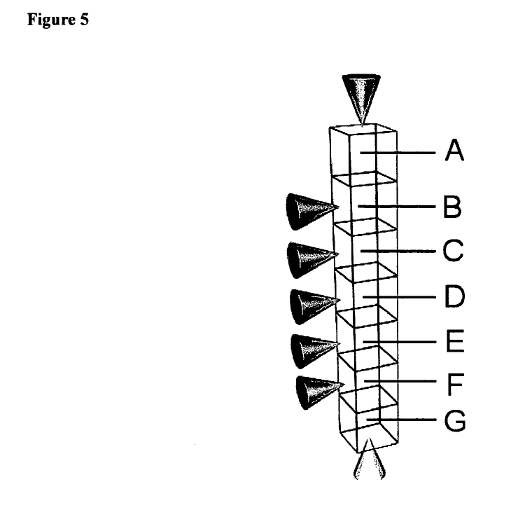

FIG. 6. Tetrahedron diagram showing Planck's constant and electron.

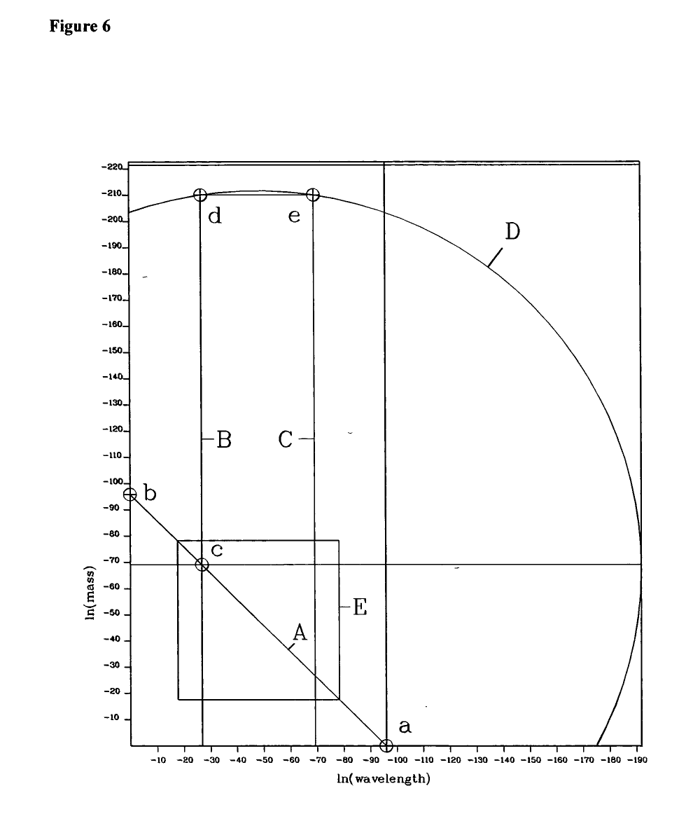

FIG. 7. Tetrahedron diagram showing electron moving out of dimension.

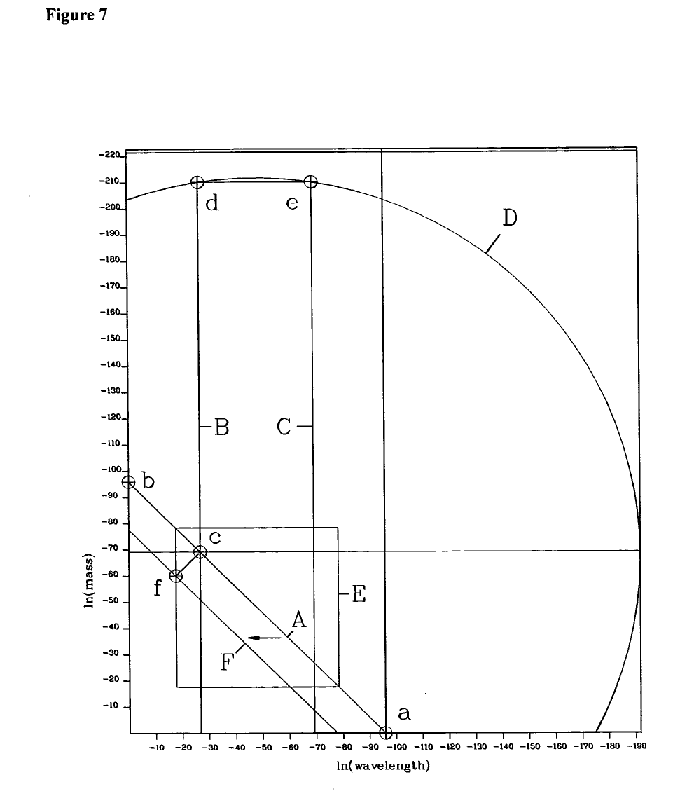

FIG. 8. Perspective view showing production of negative energy.

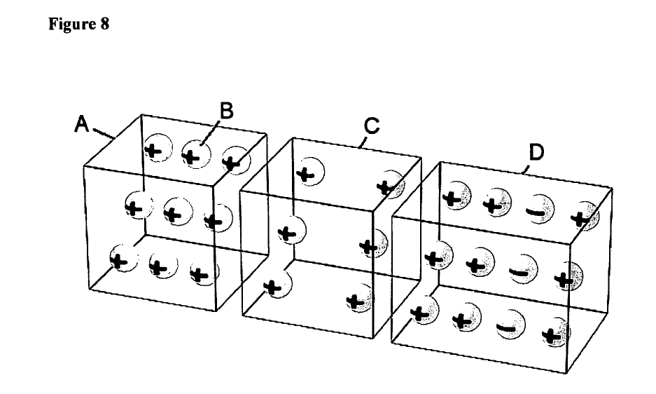

FIG. 9. Perspective view of skewed gravitational wave produced by propellers.

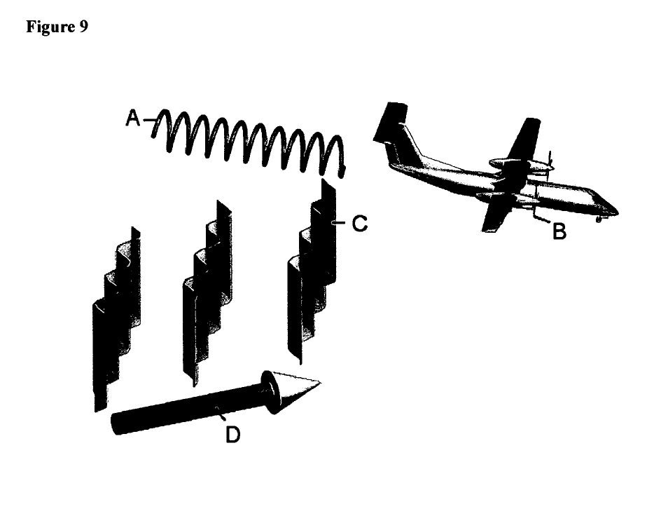

FIG. 10. Planar view of skewed quantum wells deformed by gravitational wave.

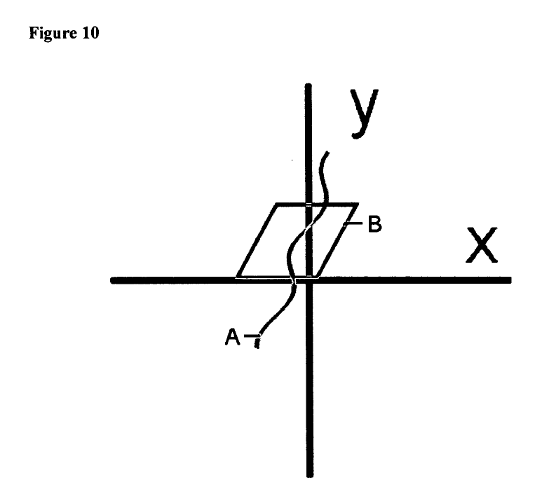

FIG. 11. Perspective view of magnetic vortex wormhole generator.

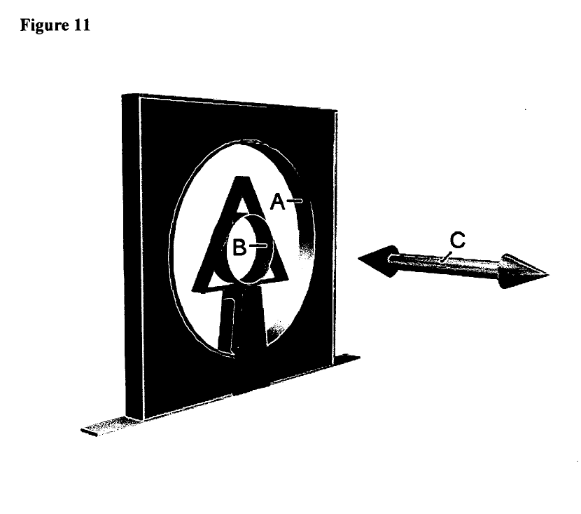

FIG. 12. Perspective view of hyperbolic lines of stress generated by toroidal waveguide.

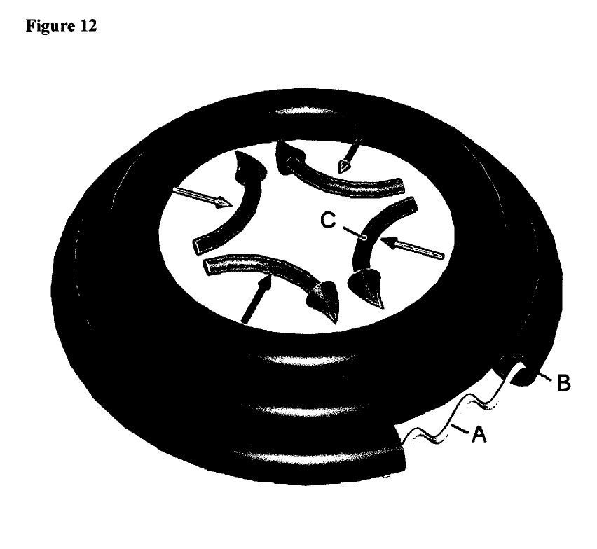

FIG. 13. Perspective view of rotating, twisting, propagating gravitational wave generated by toroidal waveguides.

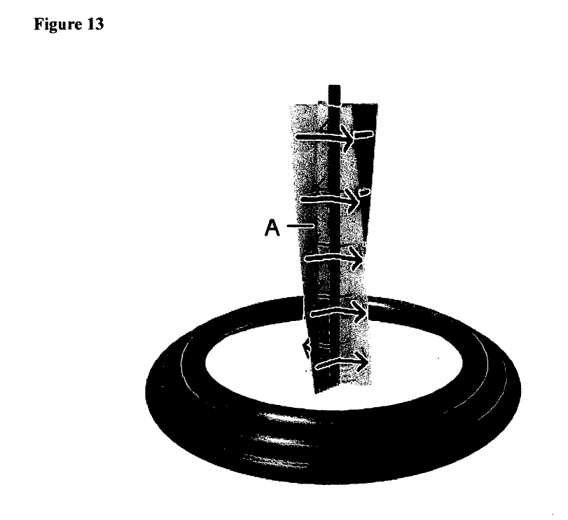

FIG. 14. Perspective view of toroidal waveguides attached to obelisks.

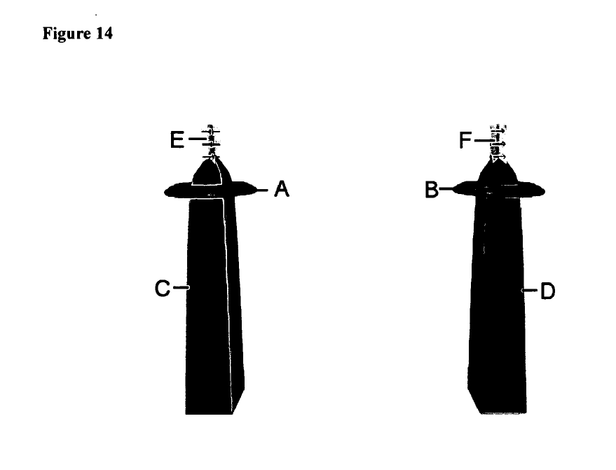

FIG. 15. Perspective view of gravitational wave generated by obelisks.

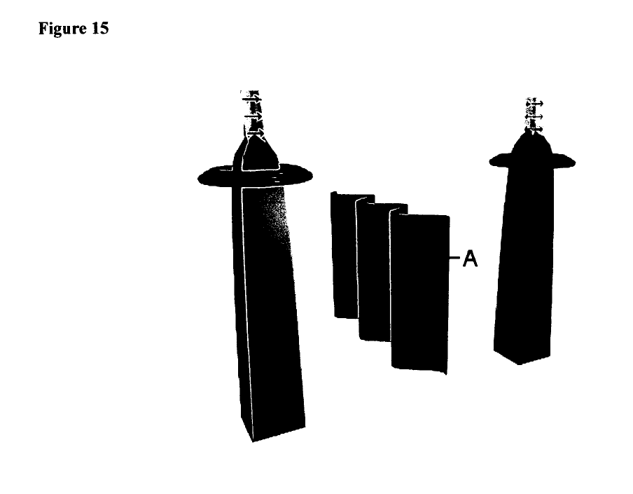

FIG. 16. Perspective view of magnetic vortex wormhole generator and obelisk gravitational wave generator.

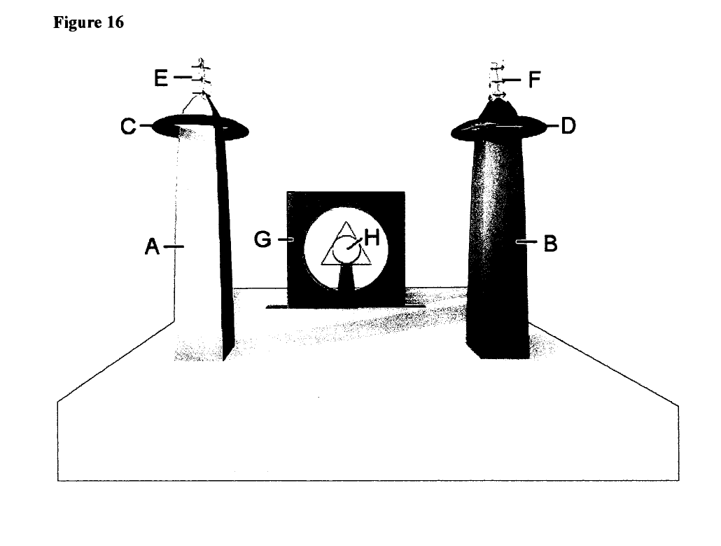

### DETAILED DESCRIPTION OF THE INVENTION

1. The obelisks are quarried out of granite stone and cut with a large-diameter diamond saw that is used in highway construction. The beveled piece at the top is cut separately and cemented in place. A tapered aluminum bracket holds the toroids in place.
2. The electronics for the magnetic vortex generator are similar to that used in the patent application Magnetic Vortex Wormhole Generator.
3. The electronics for the toroidal waveguides is the familiar stub and coaxial cable driven by an amplifier and pulsed variable-frequency generator.

I claim:

1. A full body teleportation system consisting of:
generating a pulsed gravitational wave which propagates through a magnetic vortex wormhole generator; and
generating a wormhole with the magnetic vortex generator whereby the pulsed gravitational wave traverses through the wormhole and enters into hyperspace where the wave is enormously magnified due to the lower speed of light in that dimension.

2. The method of claim 1, wherein the step of generating the pulsed gravitational wave comprises:
using two granite stone obelisks;
mounting monochromatic-wave toroidal waveguides on top of each obelisk to create a rotating, twisting, propagating gravitational wave through the vertical axis of each obelisk; and
creating a cylindrical compression and expansion in each obelisk to produce a plane gravitational wave traveling down the centerline between the two obelisks.

3. The method of claim 1, wherein the step of generating a wormhole into hyperspace comprises:
using two concentric cylindrical solenoidal coils of different radii connected by a single wire wrapped in opposite directions on thin iron transformer laminate;
generating bucking electric fields down the centerline of the vortex generator which creates a spacetime curvature distortion with negative energy in accordance with Einstein's General Theory of Relativity.

4. A teleportation system comprising:
generating a gravitational wave traveling through hyperspace which interacts with the human energy being; and
pulling the human energy being and physical body out of dimension when interacting with the pulsed gravitational wave such that the person is teleported from one location to another through hyperspace and back again into our 4D spacetime dimension.
